(19) United States
(12) Patent Application Publication
(10) Pub. No.: US 2009/0130310 A1
(43) Pub. Date: May 21, 2009

(54) Method for painting concrete

(76) Inventor: Efrem Usdenski, Cambridge (CA)

Correspondence Address: Aleksandr Smushkovich, POB 140505, Brooklyn, NY, 11214, US

(21) Appl. No.: 11/985,792

(22) Filed: Nov. 16, 2007

(51) Int. Cl. C04B 16/04

(52) U.S. Cl. 427/267

(57) ABSTRACT

A method of painting concrete for imitation of a desirable natural stone look on the concrete surface comprises determination of a base color of concrete, dissolving a first color water-soluble paint in water, applying the first color paint to the surface, drying it up to a predetermined extent, removing an excessive paint layer from ridge portions of the surface, drying up the surface, if the desirable look is achieved—applying a sealant layer over the paint layer and ending the steps, otherwise—dissolving a water-soluble paint of another color in water and repeating the mentioned steps for the other color layer. An embodiment provides the basic color by adding a dry pigment of desirable color into conventional concrete dry mixture in the amount of 0.5-2.0% of the mixture mass, intermingling the pigment with the mixture before introducing water. Preferable paint/water ratio, drying time, and sealant compositions are disclosed.

### TECHNICAL FIELD

The present invention relates to painting technologies, particularly to coloring concretes and polymer-concretes, especially for imitation of a natural stone look of the concrete surface.

### BACKGROUND OF THE INVENTION

At present the production of building materials is one of the major industries with billions-dollars turnover. Many natural and artificial materials are developed for buildings construction. Coloring solutions for construction and decorative building materials play an important role for creation of pleasant healthy environment and comfort for people. There are several methods known in the prior art dedicated to production of colored building materials, in particular, coloring concrete.

For example, U.S. Pat. No. 5,199,986 to Krockert et al mentions: “For coloring concrete materials, the pigments are generally used in powder form. When ground up as powders they have the advantage of being readily dispersible; such pigment powders can be distributed completely homogeneously in concrete mixtures within a short time of up to a few minutes. The disadvantage of these fine powders, however, is that they do not flow freely and in many cases cake together and form lumps when kept in storage. This renders accurate dosing difficult and another disadvantage of some powders is that they tend to form dust. It is known that these disadvantages can be avoided in the pigmentation of concrete parts by using aqueous pigment suspensions instead of dry pigment powders. The use of such pastes or slurries containing 30 to 70% by weight of pigment, however, has only slowly become established as the additional water content may considerably increase the transport costs, depending on the distance between the place of manufacture and the building site. Moreover, not all concrete preparations are capable of absorbing the large quantity of water carried with the pigment.”

It proposes the following solution: “Colored building materials are produced by incorporating into the building materials inorganic pigments in the form of granulates which are free-flowing and not dust forming wherein the pigments are produced from spray dried granulates by after-granulating”.

Another U.S. Pat. No. 5,215,583 to Krockert et al teaches: “Building materials are colored with pigments, for example iron oxide pigments, in the form of granules produced from a suspension of one or more pigments wherein the suspension also contains 0.05 to 5% of soluble salts, based on pigment weight.”.

A similar method is described in U.S. Pat. No. 5,322,563 to van Bonn et al: “A method for coloring building materials is disclosed, wherein a pigment suspension is added to the building materials. The pigment suspension based on pigment granules contains at least one pigment such as iron oxide, and a soluble phosphate salt. The soluble phosphate salt has a number ratio of monofunctional metal ions to phosphorus of 2:1 to 1:1, and is exemplified by sodium pyrophosphate, sodium polyphosphate, and sodium hexametaphosphate.”

Another process is disclosed in U.S. Pat. No. 6,270,566 to Rademachers et al “for coloring building materials with inorganic pigments in the form of microgranulates. The granulates comprise one or more pigments and one or more compounds selected from boron, aluminum, silicon, titanium, zinc and tin.”

U.S. Pat. No. 5,286,289 to Shankman teaches “An iron based stain and an iron coating both concurrently formed through the blending or mixture of predetermined amounts of iron particles with one of a variety of acidic solutions wherein the iron stain is defined by an acidic solution of iron oxide and the iron coating is defined by the collected, non-suspended iron particles in a slurry and/or paste-like state. The exposed surfaces of masonry, concrete, stone and like materials are thereby provided with an architecturally decorative appearance after application of either the iron stain or iron coating.” It also mentions: “the iron stain of the present invention in effect penetrates the surface or impregnates such masonry/concrete surface as it is absorbed.”

### BRIEF PRIOR ART ANALYSIS AND SUMMARY OF THE INVENTION

It is worth to note that most of the aforementioned technologies provide coloring the building materials through imparting and distributing powder or granulated non-organic pigments in dry concrete mixtures, with subsequent blending thereof with water. Such methods however have certain drawbacks, e.g.: (a) a limited color palette of utilized pigment powders; (b) the paint or stain producers may hardly control desirable tints of a color; (c) essentially unicolor coverage of the concrete or masonry surface. Therefore such methods cannot practically provide the natural stone look (e.g. granite, limestone, etc.) for the painted surface of concrete.

On the other hand, several technologies have been proposed that include painting concretes by treating them with various chemical solutions of non-organic acids (such as the mentioned in U.S. Pat. No. 5,286,289 above). Generally, the employment of those methods allows achieving a desirable appearance of natural stones. In reality however, they are mostly deployed for “custom made” projects, but not industry-wide.

This results from a number of disadvantages of the aforesaid chemical treatment methods, for instance:

(a) the non-organic stains are significantly expensive;

(b) the non-organic stains may be applied only at least about 30 days after the complete hardening of concrete (the chemical reaction of the iron stain with the concrete material may affect the strength of concrete if it's not hardened completely);

(c) they involve harmful chemical evaporations negatively affecting the operator's health and environment;

(d) the painter's job is laborious and involves substantial skills and experience;

(e) the chemical treatment methods are mainly deployed for small areas, since it's very difficult to provide uni-pattern coverage for a large area of concrete;

(f) the final look of the so treated surface is difficult to control, since it depends on numerous factors. When the concrete is chemically treated by the non-organic stains, the color tints strongly depend on the age of concrete, surrounding temperature, time of treatment by the chemical stain before the washing out of the excessive layers of stain from the painted surface with water. Besides, even after the painting process, the concrete article may change its color until the chemical reactions taking place in the porous structure of material (wherein the stain has penetrated) will eventually end. Also, when two or more chemical pigments are mixed or superimposed, a mutual reaction of the pigments may take place, and thus the final color resulted from the superposition can differ from the desirable one.

The inventive method is proposed to obtain a natural stone appearance of the painted concrete surface. The distinct features and advantages of the proposed technology follow:

(A) imitation of appearance practically of any natural stone; visual distinguishing natural stones and the imitated concrete colored according to the inventive method is almost impossible for lay people;

(B) the cost of painting materials is much lower (in order of 10-100 times less) than that of the aforementioned chemical treatment methods;

(C) the inventive method is characterized by minimal labor and short process time. The painting can start right after the concrete article (slab, etc.) is removed from the mold and acquires its initial hardening (about 1000-2000 psi, approximately from 24 to 72 hours depending on the sort of concrete and hardening additives used). One worker can paint 1 sq ft of concrete surface within about 10-15 seconds. This greatly facilitates commercialization of the invention;

(D) the proposed inventive method allows for control of the final appearance of painted surface to a much greater extent than the mentioned chemical treatment methods. The resultant color of concrete surface does not change. An experiment has shown no color alterations for three years of outside usage in Canada's climate;

(E) the inventive technology does not require experienced personnel;

(F) the method is harmless to operators and the environment;

(G) the inventive method is applicable not only to conventional concretes, but to polymer concretes as well.

The inventive non-chemical method for painting concrete is based on absorption of predetermined water-paint solutions by a porous structure of the concrete surface, which absorption is provided for a desirable extent, due to sequential applying the solutions layers of chosen colors onto the concrete surface, drying the applied layers, partially removing excess of the applied layers from ridges of the surface preferably with a wet rag or sponge, and repeating the applying of chosen colored solutions and the removing of the excessive applied layers until a desirable color pattern of the concrete surface is achieved, which pattern imitates a natural stone appearance.

### PREFERRED EMBODIMENTS OF THE PRESENT INVENTION

While the invention may be susceptible to embodiment in different forms, there are described in detail herein, specific embodiments of the present invention, with the understanding that the present disclosure is to be considered an exemplification of the principles of the invention, and is not intended to limit the invention to that as described herein.

The proposed method comprises a first step for determination of a base color (the color of concrete itself for imitation of a natural stone look of the concrete surface.

An optional step then can be taken that includes: providing a conventional concrete dry mixture with a predetermined mass for concrete preparation, adding a dry non-organic pigment of a desirable color in the amount of 0.5-2.0% of the predetermined mass to the mixture, and intermingling the pigment with the concrete mixture before introducing water into the mixture. This optional step provides an initial (base) color of the concrete. In some embodiments of the inventive method this step can be omitted, so that the concrete would have its common gray base color.

The next step is a dissolving of a predetermined amount of any qualitative water-soluble paint in water. The paint is selected of a certain color. The predetermined amount of paint is chosen based on the density of the paint, its initial color, and the desirable end color for the concrete surface. The preferable range of a paint/water ratio should be arranged from 1/10 to 1/4.

In a preferred embodiment, an epoxy-based water-soluble paint is recommended for preparation of the concrete paint. Good results have been attained with a paint product called “Expressions CureCoat”™ of Masterchem Industries LLC, since it possesses sufficient adhesion to the concrete material.

It is recommended to carry out the painting in one of the following manners: (a) starting from lighter tints or colors subsequently changing to darker tints or colors; and (b) going in the opposite direction: from the darker to the lighter tints or colors.

The next step is an applying of the paint to the concrete surface. A traditional paintbrush, sprayer, or pulverizer can be deployed for the painting. The layer of paint applied to the concrete surface should be as thin as possible that facilitates adhesion of the paint to the concrete and accelerates drying the paint up to a predetermined extent.

The predetermined extent depends on the properties of concrete (e.g. porousness), the initial humidity of concrete, the surrounding temperature, the paint concentration in the water-paint solution, other paint's properties, thickness of the paint layer applied, a mode of drying (e.g., an enforced mode—i.e. drying by a fan, etc. or a non-enforced mode), and so on. For non-enforced drying at a room temperature (about 20.degree.C) the drying time is typically ranged from 15 to 40 minutes. It may be determined based on a simple experiment: the excessive paint layer cannot be removed by a dry rag (sponge), but can be removed by a wet rag (sponge).

The porous structure of the concrete surface is normally capable to absorb a certain amount of the water-paint solution. Ridge (outstanding or convex) concrete surface portions typically absorb less paint than concave-like portions of the surface that collect a thicker layer of paint. In fact, the concrete is not covered, filmed, or coated by paint or stain (as in most prior art methods), but the paint impregnates or soaks the pores of the concrete surface. On the other hand, the inventive method differs from aforesaid chemical treatment methods in that the paint collected in the pores does not chemically react with the material of concrete, and therefore the surface color pattern does not essentially change in time.

The following step is a removing (wiping out) of an excessive layer of paint from the ridge portions of the concrete surface by means of a wet rag (or sponge), leaving a very thin layer, which displays just a slightly noticeable tint of the applied paint's color.

The sealant should be applied to a clean dry surface with a paintbrush, paint roller, or sprayer. Instructions of sealant manufacturer have to be followed. Particularly, a sealant ‘WL’™ produced by Techni-Seal showed good results, though others can be tried. The sealant can be freshly applied after concrete slabs have been produced, painted, and dried out completely. The sealant can also be applied after an installation of the slabs. Yet, the sealer should be used to cover the painted concrete surface every 2-3 years during common maintenance.

The invention can be utilized in the building materials industry for decoration of exterior or interior concrete elements, e.g. for covering driveways, pavements, patios, terraces, and so on.

It will be understood that each of the steps or elements described above, or two or more together, may also find a useful application in other types of constructions and methods differing from the types described above.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1-6. (canceled)

7. A method of painting polymer concrete for imitation of a desirable natural stone look of the concrete surface, said concrete surface including ridge portions, said method comprising the steps of:
a) determination of a base color of the concrete;
b) providing a polymer concrete dry mixture with a predetermined mass for concrete preparation, adding a dry pigment of the base color in the amount of 0.5-2.0% of the predetermined mass to the mixture, and intermingling the pigment with the concrete mixture before introducing water into the mixture;
c) dissolving a predetermined amount of a predetermined water-soluble paint of a first color in a predetermined amount of water;
d) applying a layer of the first color paint to the concrete surface;
e) drying up said first color layer to a predetermined extent;
f) removing an excessive layer of paint from the ridge portions of the concrete surface;
g) drying up the concrete surface;
h) if said desirable natural stone look is achieved, applying a sealant layer over the paint layer and ending the steps, otherwise carrying out step (i);
i) dissolving a predetermined amount of a predetermined water-soluble paint of another color in a predetermined amount of water; and
j) repeating the steps from (d) to (h) for the other color layer.

8. The method according to claim 7, further including a step:
k) applying slight traces of paint with a dry paintbrush to achieve an additional imitation effect of natural stones.
